(19) United States
(12) Patent Application Publication
(10) Pub. No.: US 2025/0029110 A1
(43) Pub. Date: Jan. 23, 2025

(54) SYSTEM AND METHOD FOR AUTOMATED TESTING OF CUSTOMER SUPPORT CHATBOTS

(71) Applicant: ADA Support Inc., Toronto (CA)

(72) Inventors: Charles Clayton Wooters, Livermore, CA (US); Ron Harlev, San Francisco, CA (US); Ives José de Albuquerque Macêdo, JR., North Vancouver (CA); George Seif, Toronto (CA); Yochai Konig, San Francisco, CA (US)

(21) Appl. No.: 18/353,759

(22) Filed: Jul. 17, 2023

(51) Int. Cl. G06Q 30/015; G06N 5/04; H04L 51/02

(52) U.S. Cl. CPC G06Q 30/015; G06N 5/04; H04L 51/02

(57) ABSTRACT

A method of evaluating performance of a chatbot includes identifying a test scenario including a request and an expected outcome, initiating an automated conversation between a first machine learning model and the chatbot based on the test scenario, storing a recording of the automated conversation, providing the recording of the automated conversation and the test scenario to a second machine learning model, and receiving an evaluation of the automated conversation from the second machine learning model based on the recording of the automated conversation and the expected outcome.

### FIELD

One or more aspects of embodiments according to the present disclosure relate to natural language processing, and more particularly to automated testing of customer support chatbots.

### BACKGROUND

A business may employ automated systems and representatives of the business to process transactions and/or service the needs of its customers. Utilizing human agents to interact with the customers may sometime result in delays if the agents are not available to service the customers. Utilizing human agents may also be costly for the business due to increased overhead and increased complexity to the business operation.

One mechanism for handling customer needs in a more efficient manner may be to employ a question answering system (hereinafter referred to as a chatbot or chatbot system). Using chatbots, however, may be challenging. For example, if a chatbot has not been trained to recognize a particular user question, the chatbot may not be effective in responding to the question, and may be unable to handle the customer's needs.

Testing an automated customer-support chatbot prior to deployment and evaluating changes to the chatbot to measure whether the changes provide better performance are crucial to ensure a seamless and efficient user experience. A comprehensive testing phase allows developers to identify and rectify potential flaws, inaccuracies, or gaps in the chatbot's knowledge base and language understanding. This process is essential to maintain the chatbot's credibility, as it can significantly reduce the risk of frustrating or misleading customers with erroneous or unhelpful responses.

The above information disclosed in this Background section is only for enhancement of understanding of the background of the present disclosure, and therefore, it may contain information that does not form prior art.

### SUMMARY

Aspects of some embodiments of the present disclosure are directed to a system and method for automatically testing the performance of a chatbot.

Aspects of some embodiments of the present disclosure are directed to a chatbot evaluation system that automates the testing process of a chatbot and the evaluation process of the tests performed across a wide range of users and scenarios.

According to some embodiments of the present disclosure, there is provided a method of evaluating performance of a chatbot, the method including: identifying a test scenario including a request and an expected outcome; initiating an automated conversation between a first machine learning model and the chatbot based on the test scenario; storing a recording of the automated conversation; providing the recording of the automated conversation and the test scenario to a second machine learning model; and receiving an evaluation of the automated conversation from the second machine learning model based on the recording of the automated conversation and the expected outcome.

In some embodiments, the request is a task to be performed or a question to be answered by the chatbot to generate the expected outcome.

In some embodiments, the method further includes: providing customer-specific data including at least one of knowledge base data and application programming interface (API) description to the chatbot, wherein the chatbot is configured to engage in the automated conversation further based on the at least one of the customer-specific data and the API description.

In some embodiments, the chatbot is configured to make an API call based on the request and the API description.

In some embodiments, the knowledge base data includes a plurality of articles, and the request is a question to be answered by the chatbot, and the chatbot is configured to respond to the request based on the plurality of articles.

In some embodiments, the method further includes: providing one or more articles of the plurality of articles to a third machine learning model to generate the question; receiving the question from the third machine learning model based on the one or more articles; and identifying the question as the request.

In some embodiments, the method further includes: providing one or more articles of the plurality of articles to a third machine learning model to generate a synthetic question; receiving the synthetic question from the third machine learning model based on the one or more articles; querying a database including historical customer questions based on the synthetic question; receive a historical question that has semantic similarity to the synthetic question; and identifying the historical question as the request.

In some embodiments, the method further includes: providing the plurality of articles and a plurality of historical questions to a third machine learning model; receiving a non-KB-answerable question from the third machine learning model, the non-KB-answerable question being one among the plurality of historical questions that is not answerable based on the plurality of articles; and identifying the non-KB-answerable question as the request.

In some embodiments, the method further includes: providing the plurality of articles to a third machine learning model to generate a synthetic question; receiving a plurality of synthetic questions from the third machine learning model based on the plurality of articles; querying a database including historical customer questions based on the synthetic question; receive a historical question that is semantically distant from the synthetic question; and identifying the historical question as the request.

In some embodiments, the chatbot is web-based, and the first machine learning model and the chatbot are configured to engage in the automated conversation over a text-based interface.

In some embodiments, the chatbot is voice-based, and the first machine learning model and the chatbot are configured to engage in the automated conversation via a text-to-speech and speech-to-text interface.

In some embodiments, each of the first and second machine learning models includes a generative large language model (LLM).

In some embodiments, the method further includes: generating a prompt according to the test scenario, the prompt identifying a task or question for generating the expected outcome, wherein the initiating the automated conversation between the first machine learning model and the chatbot includes: providing the prompt to the first machine learning model.

In some embodiments, the method further includes: identifying at least one feature associated with a simulated user; and providing the at least one of feature to the first machine learning model, wherein the initiating the automated conversation between the first machine learning model and the chatbot is further based on the at least one feature.

In some embodiments, the at least one feature includes at least one of a personality from among a plurality of personalities, a back-story from among a plurality of back-stories, an age from among a plurality of ages, and a job title from among a plurality of job titles.

In some embodiments, the identifying the at least one feature includes at least one of: randomly selecting the personality from among the plurality of personalities; randomly selecting the back-story from among the plurality of back-stories; randomly selecting the age from among the plurality of ages; and randomly selecting the job title from among a plurality of job titles.

In some embodiments, the evaluation of the automated conversation includes a label including one of a resolved label, a not-resolved label, and an unclear label, and the evaluation from the second machine learning model further includes at least one of a reason for the label and an opportunity for improvement.

In some embodiments, the method further includes: tracking a percentage of conversations including the automated conversation having the resolved label; and identifying suggestions for improvement of the chatbot based on the at least one of the reason for the evaluation and the opportunity for improvement.

In some embodiments, the evaluation of the automated conversation includes a label including one of an attempted-to-answer label and a no-attempt-to-answer label.

According to some embodiments of the present disclosure, there is provided a system for evaluating performance of a chatbot, the system including: a processor; and a memory, wherein the memory includes instructions that, when executed by the processor, cause the processor to perform: identifying a test scenario including a request and an expected outcome; initiating an automated conversation between a first machine learning model and the chatbot based on the test scenario; storing a recording of the automated conversation; providing the recording of the automated conversation and the test scenario to a second machine learning model; and receiving an evaluation of the automated conversation from the second machine learning model based on the recording of the automated conversation and the expected outcome.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 illustrates a block diagram of a chatbot evaluation system for testing and evaluating a chatbot, according to some embodiments of the present disclosure.

FIG. 2 illustrates a block diagram of a test scenario generator, according to some embodiments of the present disclosure.

FIG. 3 is a flow diagram illustrating the process of evaluating the performance of the chatbot, according to some embodiments of the present disclosure.

FIG. 4 is a flow diagram illustrating the process of generating a test scenario for evaluating the performance of the chatbot, according to some embodiments of the present disclosure.

FIG. 5 is a block diagram of a computing device, according to some embodiments of the present disclosure.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

A business may employ an automated answering system, a chat bot, a chat robot, a chatterbot, a dialog system, a conversational agent, and/or the like (collectively referred to as a chatbot) to interact with customers. Customers may use natural language to pose questions to the chatbot, and the chatbot may provide answers that are aimed to be responsive to the questions.

Prior to deploying a chatbot in production, it is desired to have it tested on a wide range of customer queries, reflecting as much of the diversity and variation in the chatbot's expected user population as possible. A chatbot that is better equipped to handle a wide range of customer queries may reduce the workload of human support agents and increase overall customer satisfaction. The greater the number of tests a chatbot developer can conduct, the more extensively they can explore the chatbot's configuration “space”. This exploration may aid in identifying a suitable chatbot configuration, which in turn may result in improved performance and accuracy.

Accordingly, aspects of the present disclosure are directed to a chatbot evaluation system that utilizes machine learning to automate the testing process of a chatbot and the evaluation process of the tests performed, across a wide range of users and scenarios. The chatbot evaluation system according to some embodiments is capable of simulating a fuller range of real-world user actions for testing a chatbot than the manual or semi-automated methods employed by the related art

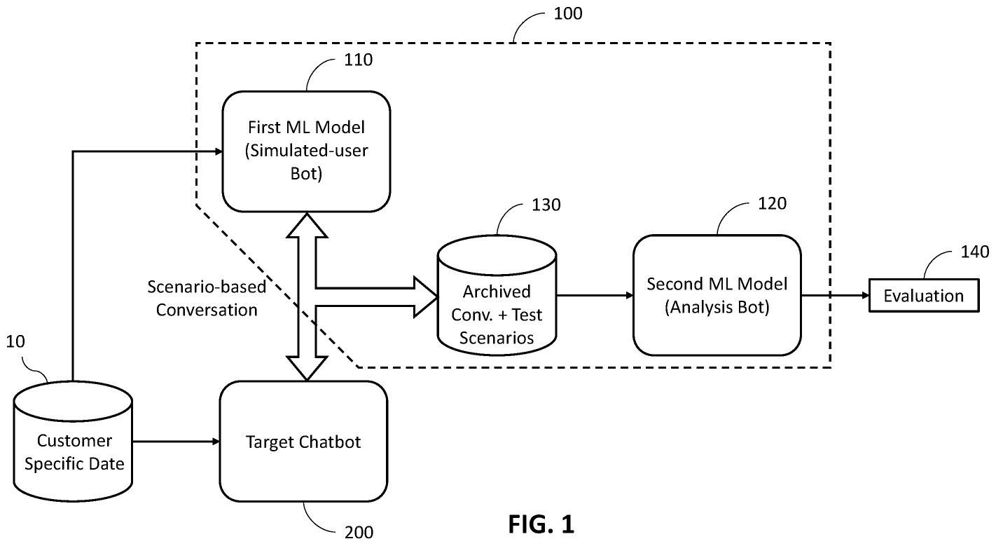

FIG. 1 illustrates a block diagram of the chatbot evaluation system 100 for testing and evaluating a chatbot 200, according to some embodiments of the present disclosure.

In some embodiments, the chatbot evaluation system 100 includes a first machine learning model 110, which may be configured as a simulated-user bot for engaging in conversation with the chatbot (e.g., a customer support chatbot; also referred as a “target bot”) 200, and a second machine learning model 120, which may be configured as an analysis bot for analyzing and evaluating the conversation between the first machine learning model 110 and the chatbot 200. Each of the first and second machine learning models 110 and 120 may include one or more generative large language models (LLMs). Some recent examples of an LLM include a Bidirectional Encoder Representations and Transformers (BERT) model, OpenAI's Generative Pre-Trained Transformer 4 (GPT-4), and Anthropic's Claude), although embodiments are not limited thereto. The first machine learning model 110 and the second machine learning model 120 may be different models; however, embodiments of the present disclosure are not limited thereto, and the first and second machine learning models 110 and 120 may be the same model or instances of the same model.

The first machine learning model 110 may simulate a diverse population of chatbot users. Each user simulated by first machine learning model 110 may be assigned a personality (e.g., characteristic mood), a demographic, a back-story, and a test scenario, which the model 110 uses to engage in a scenario-based conversation with the chatbot 200 that is the target of the test.

For example, the first machine learning model 110 may conduct the conversation by adopting the assigned personality/mood (e.g. friendly, impatient, etc.) and the general “dimensions” such as age, gender, language, location, and personal histories (e.g. “You live in San Francisco, California. You are a 33 year old CEO of a successful company. Your native language is English, but you also speak Spanish fluently. Your hobbies include watching Sci-Fi movies, watercolor painting, and ax throwing, etc.”)

The test scenario may include a request and an expected outcome, where the request is a task to be performed or a question to be answered by the chatbot 200 to generate the expected outcome. An example task may be “query for the weather for Toronto” and the corresponding expected outcome may be the current weather in Toronto, for example, “25 degrees and sunny”. The request may be provided to the first machine learning model 110 as its goal, and the first machine learning model 110 may start a conversation with the chatbot 200 and try to complete the request (e.g., to perform the task or answer the question). For example, the chatbot 200 may query an application programming interface (API) for the weather forecast for Toronto and return the result as the expected outcome. If the chatbot 200 does not have the ability to query for the weather forecast, the test would fail.

When engaging in conversation with the chatbot 200, the first machine learning model 110 may only use the inputs provided by the test scenario when responding to questions from the chatbot 200. For example, when the request of the test scenario is the task of obtaining the weather forecast for the city of New York, and the chatbot 200 asks for a location, the first machine learning model 110 is configured to only respond with information consistent with “New York”, such as “New York”, “The big apple”, “NYC”, etc., and does not use any other location than what is given in the specific test scenario. Further, the first machine learning model 110 is configured to remain on topic when engaged in conversation with the chatbot 200. For example, if the goal of the test scenario is to obtain the weather forecast, the first machine learning model 110 does not ask about travel information, or stock prices, etc. Additionally, the first machine learning model 110 may end the conversation after obtaining the information it is seeking based on the test scenario request, and does not continue the conversation with the chatbot 200 beyond that.

Here, the conversation may be text or voice based. For example, when the chatbot 200 is web-based, the first machine learning model 110 and the chatbot 200 may be configured to engage in the automated conversation over a text-based interface. Further, when the chatbot 200 is voice-based, the first machine learning model and the chatbot may be configured to engage in the automated conversation via a text-to-speech and speech-to-text interface. Further, the first machine learning model 110 connects to the chatbot 200 via the same interface that an actual user would use. Thus, for a text-based interface, the first machine learning model 110 may navigate to the web-site that is hosting the chatbot 200, click on the “Chat” button, for example, and carry out the conversation, just as a human user would do. When there is an API for interfacing with the web-based chatbot 200, that may be used instead of using a web-browser-based interface. Further, for a voice-based chatbot 200, the first machine learning model 110 may call in to the chatbot 200 and carry out the conversation using speech-to-text and text-to-speech technologies.

The chatbot evaluation system 100 stores (e.g., archives) a recording (e.g., a transcript) of the conversation between the first machine learning model 110 and the chatbot 200, along with the test scenario, for future analysis by the second machine learning model 120.

In some examples, the test scenarios are stored at a first database 10 that may be accessible to both of the chatbot evaluation system 100 and the chatbot 200. The first database 10 may also store customer-specific information, such as informational articles, historical user questions, APIs that the customer has access to, the customer's knowledge base, and/or the like. The chatbot evaluation system 100 may store the recorded conversation and the corresponding test scenario in a second database 130.

According to some embodiments, the chatbot evaluation system 100 utilizes a metric called “Automated Resolution Rate” to evaluate the performance of all of the chatbot 200 based on the recorded conversations and expected outcomes. The metric measures the percentage of conversations that a bot can successfully resolve. To determine if a conversation was successfully resolved, the second machine learning model 120 reviews (e.g., “reads”) the transcript of the conversation that occurred between the first machine learning model 110 and the chatbot 200, and makes a judgment as to whether the chatbot 200 had successfully resolved the (e.g., customer issue) in the corresponding test scenario. In some embodiments, the chatbot evaluation system provides the test scenario (e.g., the expected outcome) corresponding to each conversation to the second machine learning model 120 to aid it in making its determination. This is particularly useful when analyzing conversations with a chatbot 200 that has the ability to respond with “dynamic” information (such as the weather, stock prices, etc.). In such examples, the second machine learning model 120 can evaluate whether the chatbot 200 is “doing the right thing” by determining if the expected outcome was achieved. Once the evaluation is complete, the second machine learning model 120 generates an evaluation 140 of the conversation.

In some embodiments, the evaluation 140 includes a label, which may be one of a “resolved” label for when the chatbot 200 successfully achieved expected outcome (e.g., by resolving a customer issue from the test scenario), a “not-resolved” label for when the chatbot 200 did not achieved expected outcome (e.g., did not resolve the customer issue), and an unclear label for when it is not clear if the chatbot 200 achieved the desired result. The evaluation 140 may further include a reason as to why for a particular judgment was made the label and/or a suggestion for making improvements to the chatbot configuration. This extra information may then be aggregated and used as feedback to improve the chatbot's future performance.

An example of the input and output of the second machine learning model 120 and the corresponding expected outcome of a test scenario relating to bank deposit limits is as follows:

```
Input:
<transcript>
  Customer: What's the limit I can deposit each day
  Chatbot: The daily deposit limit is $500 for debit card
funding or ACH.
</transcript>
<expected>
For your protection, we do have several limits in place. Our
current limits are:
$500 Daily deposit limit for debit card funding or ACH.
$2,000 Monthly deposit limit for debit card funding or ACH.
$2,000 daily spending/transfer limit.
</expected>
Output:
<analysis>
resolution: Resolved
reason: The chatbot provided the correct daily deposit limit
information.
opportunity: no improvement needed.
</analysis>
```

The chatbot evaluation system 100 may track a percentage of conversations that have the “resolved” label.

While the evaluation 140 may include a “resolved”/“not-resolved”/“unclear” label, embodiments of the present disclosure are not limited to such labels. For example, the evaluation 140 may instead include an “attempted-to-answer” label for when the chatbot made an attempt to respond to the request of the test scenario and a “no-attempt-to-answer” label for when the chatbot 200 did not make a successful attempt to respond to the request (this will be described in further detail below).

One or more of the test scenarios utilized by the chatbot evaluation system 100 to test the chatbot 200 may be generated manually (e.g., by one or more users); however, embodiments of the present disclosure are not limited thereto. Indeed, in some embodiments, at least some of the test scenarios may be automatically generated by a test scenario generator that utilizes an LLM. This test scenario generator may be part of the chat evaluation system 100 or may be external to it and be utilized by a bot developer to provide at least some of the test scenarios and simulated user data used by the chat evaluation system 100 to test the chatbot 200.

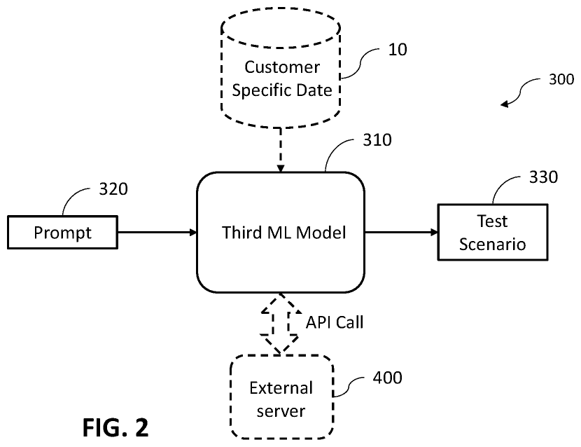

FIG. 2 illustrates a block diagram of a test scenario generator 300, according to some embodiments of the present disclosure.

Referring to FIG. 2, in some embodiments, the test scenario generator 300 includes a third machine learning model 310, which may be a generative LLM, that receives a prompt 320 and generates a test scenario 330 based on the prompt 320. The test scenarios may be API based, KB based, and or non-KB based.

According to some embodiments, the third machine learning model 310 is presented with a textual description of an API call to an external server 400, including the arguments that are used to make the API call. Then, the third machine learning model 310 may be asked to generate example API calls with fake data. For example, when using an API that is capable of returning the weather forecast given a location, the API call may be described to an LLM as:
GET_WEATHER_FORECAST (GEOGRAPHIC_LOCATION)
   this API returns the weather forecast for the given geographic location.

The third machine learning model 310 may then be prompted to generate several example API calls using fake locations and corresponding fake return values (weather forecasts). The prompt for this may look like the following:
Here is a description of an API call:
GET_WEATHER_FORECAST (GEOGRAPHIC_LOCATION)
   this API will return the weather forecast given a geographic location
Please generate 10 example input/output pairs for this API call using fake but realistic values for the inputs and outputs.

The third machine learning model 310 may then generate the following output:
input: “San Francisco”, output: “Foggy in the morning,
clearing by noon, with a high of 72F”
input: “San Diego”, output: “Sunny and warm with a high of 75F”

Each of these input-output combinations may form a test scenario.

While the above description provides examples of test scenarios from the perspective of external API calls, embodiments of the present disclosure are not limited thereto.

For example, the chatbot evaluation system 100 may be employed to perform a type of automated testing on the chatbot 200 that is focused on answering user's questions using information in a client's knowledge-base (KB). In such examples, the database 10 may include a collection of articles, which may include content similar to that of a client's FAQ pages on their websites, among other things. Here, the test scenario generator 300 may generate a test scenario by forming a question (e.g., a synthetic question) from an article from a KB. The first machine learning model 110 may then connect to the chatbot 200 and pose the question. The conversation evaluation process may be the same as described above for evaluating API-focused test scenarios, except that the expected outcome or answer may be the KB article from which the synthetic question was generated.

To ensure that the generated question is representative of the way an actual user would ask a question, in some embodiments, the chatbot evaluation system 100 uses the synthetic question to query a dataset of “historical” customer questions (which may be stored at the database 10 or another database). The query may only return a historical question that has a high “semantic similarity” to the synthetic question. The first machine learning model 110 then presents this historic question (rather than the synthetic question) to the chatbot 200. Here, it is assumed that when a historical question has a high semantic similarity to the synthetic question, then it should be answered by the same KB article from which the synthetic question was generated.

In some examples, semantic similarity may be measured by generating n-grams of the words contained in a historical question and n-grams of the words contained in the synthetic question, and comparing the n-grams to determine overlap between the historical and synthetic questions. The amount of overlap in the n-grams may be used as a measure of semantic similarity. In addition or in lieu of n-grams, a cosine similarity measure may be used to compute the semantic similarity between the historical and synthetic questions. In some embodiments, semantic similarity may be computed by transforming the historical and synthetic questions into respective vectors, and computing a similarity measure between the vectors. The vectors may be generated using an LLM, such as BERT. The similarity measure may be a BERTScore, a measure of vector similarity based on BERT. However, these are merely examples, and semantic similarity may be determined using any suitable technique. Here, texts that have a semantic similarity measure below a first threshold may be considered semantically distant, and those that have a semantic similarity measure above a second threshold may be considered semantically similar. The first and second thresholds may be the same, or the second threshold may be greater than the first threshold.

In the API-based and KB-based testing described above, the tests and evaluations performed by the chatbot evaluation system 100 on the chatbot 200 focus on testing the chatbot's ability to resolve a customer issue by performing an API call (e.g., changing a billing address) that is within its scope of capability and/or to answer questions or to have conversations regarding topics it is expected to know about. However, it is desirable to also ensure that the chatbot 200 does not attempt to answer questions or perform API calls that are outside of its scope of knowledge and capability. As such, in some embodiments, the chatbot evaluation system 100 is also capable of testing the chatbot 200 with test scenario requests that the chatbot is not capable of answering based on the client's knowledge base or available API. In such cases, it is expected that the chatbot 200 not attempt to respond to the request, as any attempt to answer may result in incorrect information being provided.

In some embodiments, the third machine learning model 310 is capable of accessing the entire list of articles from a client's KB (e.g., from the first database 10), and is presented with a list of historical customer questions (e.g., a list of randomly-selected historical questions) as part of the prompt 320 and asked to identify those of the historical questions that are not answerable by the information in the KB articles. Once the third machine learning model 310 identifies the non-KB-answerable questions, the chatbot evaluation system 100 may use them as test scenarios for testing the chatbot 200, where the expected answer (or expected outcome) is nothing (e.g., instead of the expected answer being the KB article).

According to some examples, to determine which historical question is unanswerable based on the client's knowledge base, the third machine learning model 310 may be prompted to identify all of the historical questions that have low semantic similarity to all of the synthetic questions for all articles in the client's knowledge base. Here, it is assumed that any historical question that is semantically distant from all synthetic questions is unanswerable based on the knowledge base. However, embodiments of the present disclosure are not limited thereto, and any other suitable method may be adopted to identify the non-KB-answerable questions.

When evaluating the chatbot 200 with non-KB-answerable questions, the second machine learning model 120 may determine whether the chatbot 200 attempted to answer the question. If it does, then the chatbot has failed the test. Thus, in such examples, the second machine learning model 120 may produce an evaluation 140 that labels the automated conversation in which the first machine learning model 110 presents the chatbot 200 with a non-KB-answerable question with either an “attempted-to-answer” label (indicating chatbot's failure) or a “a no-attempt-to-answer label” (indicating the chatbot's successful passage of the test).

According to some embodiments, the test scenarios automatically generated by the test scenario generator 300, in addition to or in lieu of manually generated test scenarios, form a pool of test scenarios from which the chatbot evaluation system 100 may draw upon to evaluate the performance of the chatbot 200. Each test scenario from the pool may be used by the chatbot evaluation system 100 to construct a prompt (e.g., a textual prompt) that is provided to the first machine learning model 110 for initiating an automated conversation with the chatbot 200. The prompt may identify a task or question for generating the expected outcome by the chatbot 200.

According to some embodiments, to further expand the scale of possible prompts to test the chatbot 200 with and to better simulate the diverse population of users that may use the chatbot 200, the chatbot evaluation system 100 may automatically generate the prompt further based on one or more features (e.g., simulated-user features) that are selected from a feature pool including different genders, personalities, backstories, demographic dimensions, and/or the like. In some examples, the database 10 may include a list of personalities (e.g., friendly, irritable, demanding, etc.), a list of ages (e.g., from 18 to 80 years), a list of job titles, a list of languages, etc., that the chatbot evaluation system 100 could draw from to programmatically construct a prompt associated with a simulated user of the chatbot 200. Thus, the chatbot evaluation system 100 may be able to simulate a wide range of users (e.g., from a disgruntled teenager to a senior person not familiar with technology).

The chatbot evaluation system 100 may generate the prompt by randomly selecting features from the lists in this feature pool (e.g. pick a gender, a personality, an age, a job title, a language, etc.). However, embodiments of the present disclosure are not limited thereto. For instance, weights or a selection probability distribution may be assigned to the different lists (e.g., the list of ages may be distributed normally with a mean of 45 and standard deviation of 20, etc.) to better match/simulate the actual user population that the chatbot 200 is intended to interact with during normal operation.

The feature pool may be stored at the database 10 along with other customer specific data.

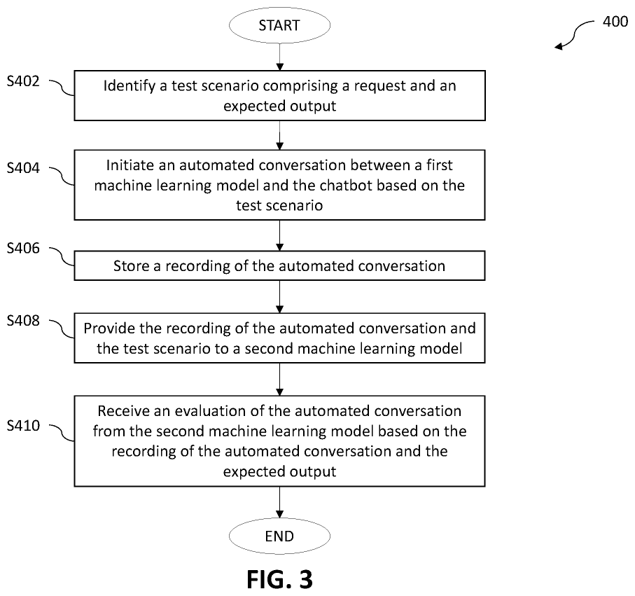

FIG. 3 is a flow diagram illustrating the process 400 of evaluating the performance of the chatbot 200, according to some embodiments of the present disclosure.

In some embodiments, the chatbot evaluation system 100 identifies a test scenario including a request and an expected outcome (S402). The request may be a task to be performed or a question to be answered by the chatbot 200 to generate the expected outcome.

Once the test scenario is identified, the first machine learning model 110 may initiate an automated conversation (e.g., automated dialogue) with the chatbot 200 based on the test scenario (S404).

In some embodiments, the chatbot evaluation system 100 may further provide customer-specific data including knowledge base data and/or API data (e.g., API description) to the chatbot 200, which is configured to engage in the automated conversation further based on the available customer-specific data and/or the API data. The knowledge base data may include a plurality of articles, and the request may be a question to be answered by the chatbot 200 based on the articles. In some examples, when engaged in the automated conversation, the chatbot 200 may utilize the API data to make an API call to elicit information needed to respond to the request.

The chatbot evaluation system 100 then stores a recording (e.g., a transcript) of the automated conversation in the second data base 130 (S406). The chatbot evaluation system 100 then provides the recording of the automated conversation and the corresponding test scenario to a second machine learning model 120 (S408), and receives an evaluation 140 of the automated conversation from the second machine learning model 120 based on the recording of the automated conversation and the expected outcome (S410).

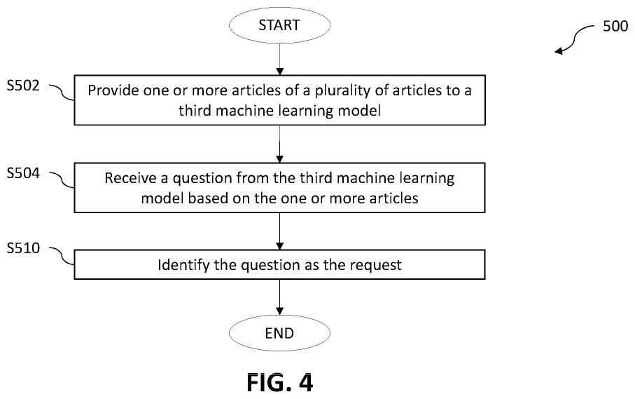

FIG. 4 is a flow diagram illustrating the process 500 of generating a test scenario for evaluating the performance of the chatbot 200, according to some embodiments of the present disclosure.

In some embodiments, the test scenario generator 300 may provide one or more articles from among a plurality of articles (which may be sourced from a client knowledge base) to the third machine learning model 310 to generate a question (e.g., a synthetic question) that serves as the test scenario request (S502). The test scenario generator 300 receives the question from the third machine learning model 310 (S504), and identifies the question as the test scenario request (S506).

In some embodiments, rather than use the synthetic question as the request, the test scenario generator 300 queries a database (e.g., the first database 10) that includes historical customer questions for a historical question that has semantic similarity to the synthetic question, and identifies the historical question as the request.

In some examples, the question may be a non-KB-answerable question that is not answerable based on the plurality of articles. In some embodiments, the test scenario generator 300 further provides a plurality of historical questions (e.g., actual user questions) to the third machine learning model 310. It may do so by querying a database (e.g., the first database 10) that includes the historical customer questions. In response, the test scenario generator 300 may return a non-KB-answerable question, which is one of historical questions that is not answerable based on the plurality of articles. This question may then be identified as the test scenario request. The non-KB-answerable question may be a historical question that is semantically distant from all of the synthetic questions generated based on the articles.

Thus, as described herein, the chatbot evaluation system 100 automates the testing process and the evaluation of the tests. This allows the system 100 to run many tests (e.g., thousands or even millions of individual tests) in a relatively short period of time. Further, because of the advanced language capabilities of today's LLMs, the machine learning models of the chatbot evaluation system 100 are able to realistically mimic the linguistic nuances, colloquialisms, and behavior of actual human users. Using this approach, a chatbot developer using the chatbot evaluation system 100 may receive an accurate evaluation of a chatbot's behavior across a wide variety of “users” and scenarios, even before its first interaction with an actual human user.

Further, the chatbot evaluation system 100 may also be utilized any time the chatbot developer intends to make changes to, or otherwise experiment with, new features, approaches, or architectures. By employing a fleet of simulated-user bots via the first machine learning model 110, the developer may ensure that any changes made to the chatbot 200 can lead to improvements in the chatbot's performance before subjecting real users to those changes.

Furthermore, the automated nature of the chatbot evaluation system provides significant time and cost savings relative to crowdsourcing methods of the related art, as it eliminates the need to recruit, onboard, and compensate a large pool of testers and avoids the need to manage and process large volumes of subjective judgments and potentially inconsistent feedback from the diverse set of testers.

Although the chatbot evaluation system 100 and the test scenario generator 300 are depicted in FIGS. 1-2 as separate components/systems, a person of skill in the art should recognize that these components/systems 100 and 300 may be combined into a single component/system, or one or more of the components may be further subdivided into additional sub-components as will be appreciated by a person of skill in the art.

Each of the first to third machine learning models 110, 120, and 310 may include, for example, deep neural networks, shallow neural networks, and the like. The neural network(s) may have an input layer, one or more hidden layers, and an output layer. One or more of the neural networks may generate one or more embeddings (also referred to as features) from an input/user query. The embeddings may be word and/or sentence embeddings that represent one or more words of the input query as numerical vectors that encode the semantic meaning of the query. In this regard, the embeddings may also be referred to as semantic representations. In one example, the embeddings may be represented as a vector including values representing various characteristics of the word(s) in the query, such as, for example, whether the word(s) is a noun, verb, adverb, adjective, etc., the words that are used before and after each word, and/or the like. In some embodiments, the embeddings may be generated by a large language model such as, for example, a BERT or ChatGPT model. In some embodiments, a deep neural network that has been fine-tuned based on user queries may be used to generate the embedding vectors, in addition or in lieu of the BERT or ChatGPT model.

In some embodiments, the systems and methods for automatically evaluating a chatbot discussed above, are implemented in one or more processors in one or more computing devices. The term processor may refer to one or more processors and/or processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAS).

The processor may be configured to perform the functions described herein. Each function may be performed by hardware, firmware, and/or software in one or more computing devices. For example, if the function is performed by software, the processor may be configured to execute instructions stored in a non-transitory storage medium (e.g. memory) that causes the processor to implement the function.

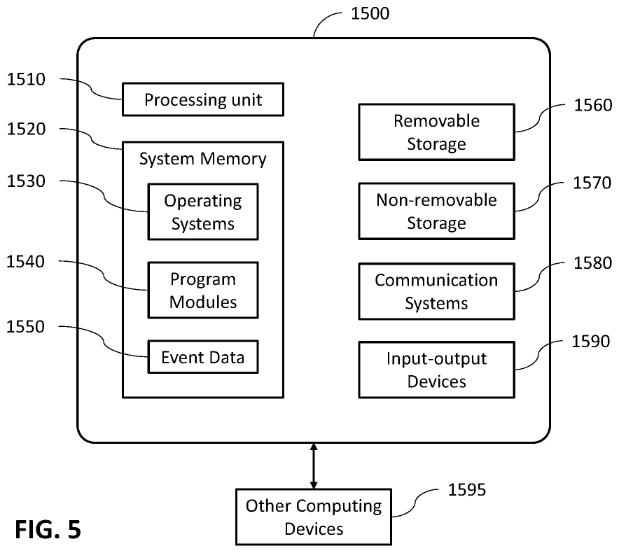

FIG. 5 is a block diagram of a computing device 1500 according to some embodiments of the present disclosure. The computing device 1500 may include at least one processing unit (processor) 1510 and a system memory 1520. The system memory 1520 may include, but is not limited to, volatile storage (e.g., random access memory), non-volatile storage (e.g., read-only memory), flash memory, or any combination of such memories. The system memory 1520 may also include an operating system 1530 that controls the operation of the computing device 1500 and one or more program modules 1540 including computer program instructions. A number of different program modules and data files may be stored in the system memory 1520. While executing on the processing unit 1510, the program modules 1540 may perform the various processes described above.

The computing device 1500 may also have additional features or functionality. For example, the computing device 1500 may include additional data storage devices (e.g., removable and/or non-removable storage devices) such as, for example, magnetic disks, optical disks, or tape. These additional storage devices are labeled as a removable storage 1560 and a non-removable storage 1570.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In some embodiments the computing device 1500 is a mobile device, such as a Java-enabled cellular telephone or personal digital assistant (PDA), a smart phone, a digital audio player, or a portable media player. In some embodiments, the computing device 1500 includes a combination of devices, such as a mobile phone combined with a digital audio player or portable media player.

According to one embodiment, the computing device 1500 is configured to communicate with other computing devices over a network interface in a network environment. The network environment may be a virtual network environment where the various components of the network are virtualized. For example, the chatbot systems 10, 1458 may be virtual machines implemented as a software-based computer running on a physical machine. The virtual machines may share the same operating system. In other embodiments, different operating systems may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

In regard to the processes in the flow diagrams of FIGS. 3-4, it should be understood that the sequence of steps of the processes are not fixed, but can be modified, changed in order, performed differently, performed sequentially, concurrently, or simultaneously, or altered into any desired sequence, as recognized by a person of skill in the art.

It will be understood that, although the terms “first”, “second”, “third”, etc., may be used herein to distinguish one element, component, or region from another. Thus, a first element, component, or region discussed herein could be termed a second element, component, or region without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of a system and method for automatically evaluating a chatbot have been specifically described and illustrated herein, many modifications and variations will be apparent to those skilled in the art. Accordingly, it is to be understood that a system and method for automatically generating suggestions of training questions constructed according to principles of this disclosure may be embodied other than as specifically described herein. The disclosure is also defined in the following claims, and equivalents thereof.

What is claimed is:

1. A method of evaluating performance of a chatbot, the method comprising:
identifying a test scenario comprising a request and an expected outcome;
initiating an automated conversation between a first machine learning model and the chatbot based on the test scenario;
storing a recording of the automated conversation;
providing the recording of the automated conversation and the test scenario to a second machine learning model; and
receiving an evaluation of the automated conversation from the second machine learning model based on the recording of the automated conversation and the expected outcome.

2. The method of claim 1, wherein the request is a task to be performed or a question to be answered by the chatbot to generate the expected outcome.

3. The method of claim 1, further comprising:
providing customer-specific data comprising at least one of knowledge base data and application programming interface (API) description to the chatbot,
wherein the chatbot is configured to engage in the automated conversation further based on the at least one of the customer-specific data and the API description.

4. The method of claim 3, wherein the chatbot is configured to make an API call based on the request and the API description.

5. The method of claim 3, wherein the knowledge base data comprises a plurality of articles, and the request is a question to be answered by the chatbot, and
wherein the chatbot is configured to respond to the request based on the plurality of articles.

6. The method of claim 5, further comprising:
providing one or more articles of the plurality of articles to a third machine learning model to generate the question;
receiving the question from the third machine learning model based on the one or more articles; and
identifying the question as the request.

7. The method of claim 5, further comprising:
providing one or more articles of the plurality of articles to a third machine learning model to generate a synthetic question;
receiving the synthetic question from the third machine learning model based on the one or more articles;
querying a database comprising historical customer questions based on the synthetic question;
receive a historical question that has semantic similarity to the synthetic question; and
identifying the historical question as the request.

8. The method of claim 5, further comprising:
providing the plurality of articles and a plurality of historical questions to a third machine learning model;
receiving a non-KB-answerable question from the third machine learning model, the non-KB-answerable question being one among the plurality of historical questions that is not answerable based on the plurality of articles; and
identifying the non-KB-answerable question as the request.

9. The method of claim 5, further comprising:
providing the plurality of articles to a third machine learning model to generate a synthetic question;
receiving a plurality of synthetic questions from the third machine learning model based on the plurality of articles;
querying a database comprising historical customer questions based on the synthetic question;
receive a historical question that is semantically distant from the synthetic question; and
identifying the historical question as the request.

10. The method of claim 1, wherein the chatbot is web-based, and the first machine learning model and the chatbot are configured to engage in the automated conversation over a text-based interface.

11. The method of claim 1, wherein the chatbot is voice-based, and the first machine learning model and the chatbot are configured to engage in the automated conversation via a text-to-speech and speech-to-text interface.

12. The method of claim 1, wherein each of the first and second machine learning models comprises a generative large language model (LLM).

13. The method of claim 1, further comprising:
generating a prompt according to the test scenario, the prompt identifying a task or question for generating the expected outcome,
wherein the initiating the automated conversation between the first machine learning model and the chatbot comprises:
providing the prompt to the first machine learning model.

14. The method of claim 1, further comprising:
identifying at least one feature associated with a simulated user; and
providing the at least one of feature to the first machine learning model,
wherein the initiating the automated conversation between the first machine learning model and the chatbot is further based on the at least one feature.

15. The method of claim 14, wherein the at least one feature comprises at least one of a personality from among a plurality of personalities, a back-story from among a plurality of back-stories, an age from among a plurality of ages, and a job title from among a plurality of job titles.

16. The method of claim 15, wherein the identifying the at least one feature comprises at least one of:
randomly selecting the personality from among the plurality of personalities;
randomly selecting the back-story from among the plurality of back-stories;
randomly selecting the age from among the plurality of ages; and
randomly selecting the job title from among a plurality of job titles.

17. The method of claim 1, wherein the evaluation of the automated conversation comprises a label comprising one of a resolved label, a not-resolved label, and an unclear label, and
wherein the evaluation from the second machine learning model further comprises at least one of a reason for the label and an opportunity for improvement.

18. The method of claim 17, further comprising:
tracking a percentage of conversations comprising the automated conversation having the resolved label; and
identifying suggestions for improvement of the chatbot based on the at least one of the reason for the evaluation and the opportunity for improvement.

19. The method of claim 1, wherein the evaluation of the automated conversation comprises a label comprising one of an attempted-to-answer label and a no-attempt-to-answer label.

20. A system for evaluating performance of a chatbot, the system comprising:
a processor; and
a memory, wherein the memory includes instructions that, when executed by the processor, cause the processor to perform:
identifying a test scenario comprising a request and an expected outcome;
initiating an automated conversation between a first machine learning model and the chatbot based on the test scenario;
storing a recording of the automated conversation;
providing the recording of the automated conversation and the test scenario to a second machine learning model; and
receiving an evaluation of the automated conversation from the second machine learning model based on the recording of the automated conversation and the expected outcome.
